(19) United States
(12) Patent Application Publication
(10) Pub. No.: US 2004/0128483 A1
(43) Pub. Date: Jul. 1, 2004

(54) Fuser renamer apparatus, systems, and methods

(75) Inventors: Edward T. Grochowski, San Jose, CA (US); Hong Wang, Fremont, CA (US); Perry Wang, San Jose, CA (US); Bryan P. Black, Austin, TX (US); John Shen, San Jose, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/335,201

(22) Filed: Dec. 31, 2002

(51) Int. Cl. G06F 9/30

(52) U.S. Cl. 712/217

(57) ABSTRACT

An apparatus may include a memory having a table indexed by a logical register identifier associated with a physical register and a memory location capable of indicating a fusible instruction associated with the physical register. A system may include a memory location capable of including an indication of a fusible instruction associated with a physical register and a bypass element to receive the indication. An article may include data, which, when accessed, results in a machine performing a method including indicating a first fusible instruction in a rename table and indicating a second fusible instruction associated with the first fusible instruction in the rename table.

### TECHNICAL FIELD

Embodiments of the invention relate generally to apparatus, systems, and methods to map registers and memory locations, including those accessed by microprocessors.

### BACKGROUND INFORMATION

A register rename table may be used to map logical registers onto physical registers. When a destination operand is written to a logical register, a physical register may be mapped to the logical register and used to retain the value of the destination operand as a source operand for subsequent read operations. However, this execution sequence may be delayed by data dependencies.

For example, in the following series of instructions:

add r1=r2+r3

load r4=[r1]

the add instruction generates a destination operand (i.e., r1) which provides the address for a load instruction as a source operand. When this illustrative sequence of operations is encountered by a processor, the add instruction is typically executed prior to the load instruction because of the data dependency that exists. In addition, separate processor functional units (e.g., an adder and an address decoder) may be augmented by a bypass multiplexer in order to accomplish the execution of these instructions in hardware. The end result is that data dependencies and/or hardware latencies may increase the amount of time required to execute instruction sequences similar to or identical to the series shown. In the interest of increasing processing speed, it may be desirable to provide a mechanism capable of reducing such delays.

### BRIEF DESCRIPTION OF THE DRAWINGS

FIG. 1 illustrates a rename table structure, including implementation as an article according to various embodiments of the invention;

FIG. 2 illustrates a rename table structure, including implementation as an article having a series of fusible instructions, according to various embodiments of the invention;

FIG. 3 is a block diagram of an apparatus, an article including a machine-accessible medium, and a system according to various embodiments of the invention; and

FIG. 4 is a flow chart illustrating a method according to various embodiments of the invention.

### DETAILED DESCRIPTION OF THE EMBODIMENTS

In the following detailed description of various embodiments of the invention, reference is made to the accompanying drawings that form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. The following detailed description, therefore, is not to be taken in a limiting sense, and the scope of various embodiments of the invention is defined only by the appended claims, along with the full range of equivalents to which such claims are entitled.

FIG. 1 illustrates a rename table structure, including implementation as an article according to various embodiments of the invention. The rename table 100 is indexed by a logical register identifier 110, and includes associated physical source register identifiers 114, associated physical destination register identifiers 118, and indications of fusible instructions 120. Physical registers 122 and fusing logic 124 may comprise combinations of software program modules, hardware, and firmware that are capable of being communicatively coupled to the table 100. Thus, the rename table 100, physical registers 122, and fusing logic 124 may be implemented as functional units within a microprocessor.

It should be noted that the layout of the table 100 is only one of many possible ways in which the information depicted therein can be shown, such that embodiments of the invention are not so limited. The table 100 may comprise a register file with multiple read and write ports, for example.

Considering the previous example of an executable instruction sequence, rewritten in a different form:

add r1=r2+r3

load r4=[r2+r3]

it can be seen that the load instruction has now been fused together with the previous add instruction. The new load instruction uses a base plus offset addressing mode to compute the sum (r2+r3), while the original add instruction remains unchanged. Thus, the original add instruction and the new load instruction may now be executed in parallel, since there is no longer a data dependency between them. Not that the original add instruction is not eliminated, since the add instruction may be needed to update r1. Fusing instructions in this manner may provide the advantage of reducing or eliminating at least one data dependency.

It should be noted that for fusing to occur, two or more instructions should possess certain characteristics. First, the instructions should be of the type that can be fused (e.g., the first fusible instruction in the immediately previous example is an add instruction, and the second fusible instruction is a load instruction). Second, the fusible instructions should be data dependent (i.e., the first fusible instruction should generate at least one destination operand that can serve as a source operand for the second fusible instruction). Such fusible instructions may include, for example, an add instruction and a load instruction (previously shown), a load instruction and a compare instruction, a compare instruction and a branch instruction, an add instruction and a multiply instruction, among numerous others.

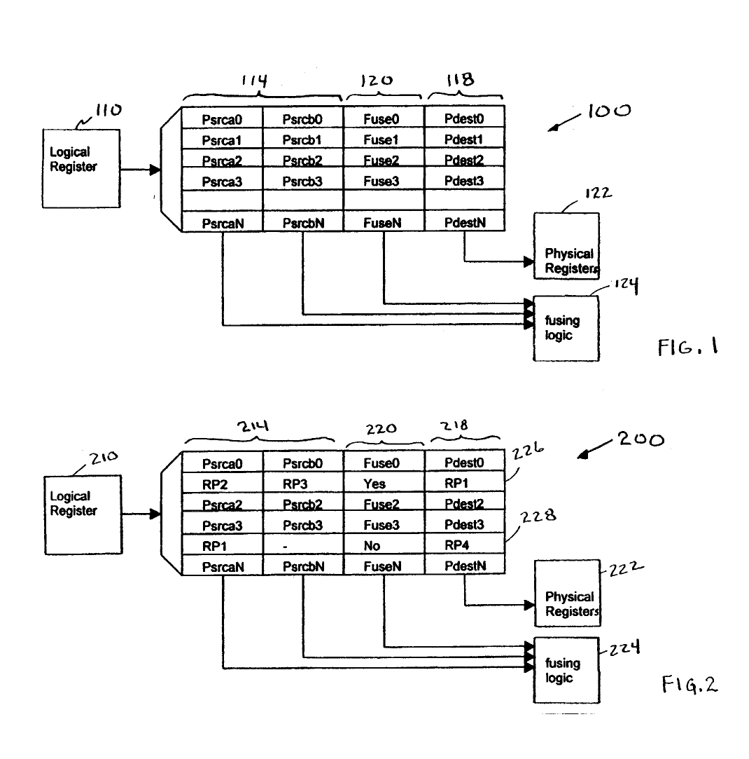

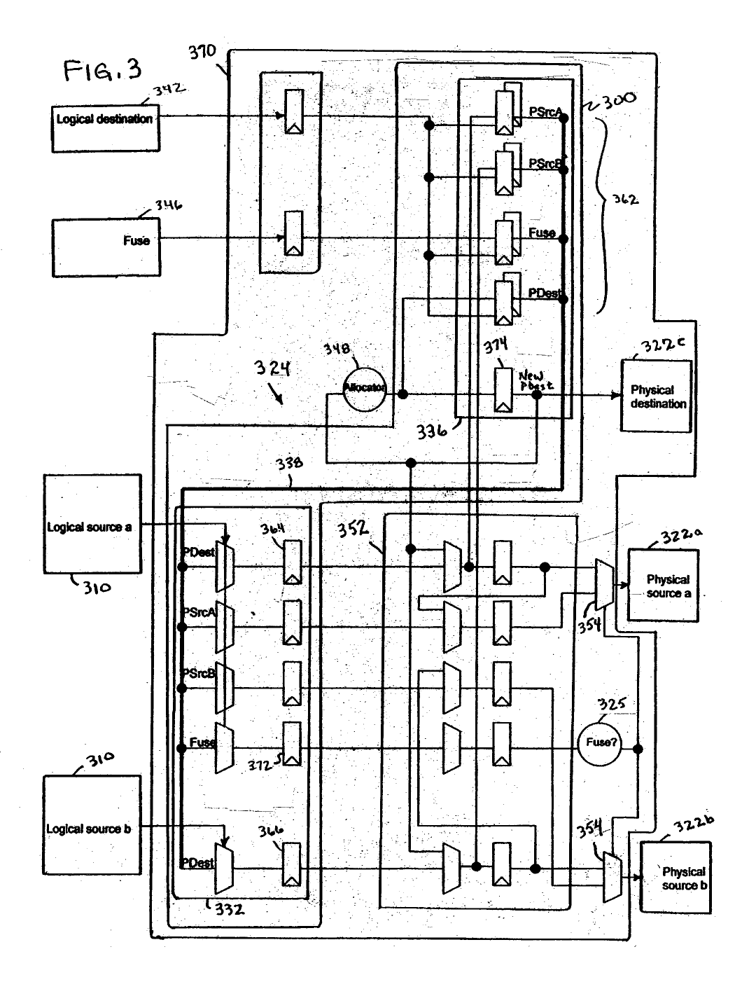

FIG. 2 illustrates a rename table structure, including implementation as an article having a series of fusible instructions, according to various embodiments of the invention. The rename table 200 includes entries associated with the first fusible instruction (i.e., an add instruction) in the first row 226. So, for example, when the first fusible instruction is renamed, the first row 226 is written in the table 200. Entries associated with the second fusible instruction (i.e., a load instruction) are included in the fourth row 228, and written when the second fusible instruction is renamed. As noted previously, the physical registers 222 and fusing logic 224 may comprise combinations of software program modules, hardware, and firmware that are capable of being communicatively coupled to the table 200, and the layout of the table 200 is only one of many possible ways in which the information depicted therein can be shown, such that embodiments of the invention are not so limited. For example, the row number of each row in the table 200, including for example the first row 226 and the fourth row 228, may correspond directly to the number of an associated logical register, such as registers RP1 and RP4 in this example.

In the circumstances captured by the particular illustration of a table 200, the information included in the first row 226 indicates that physical registers RP2 and RP3 are source registers, typically used to contain source operands, associated with the first fusible instruction (e.g., an add instruction). The physical register RP1 is indicated as a destination register associated with the first fusible instruction, and is typically used to contain a destination operand. Of course, one, two or more source registers may be associated with the first fusible instruction, as well as one, two or more destination registers, if desired.

The term “YES” in table 200 indicates that the associated instruction (i.e., the first fusible instruction) is the first fusible instruction in a series of two or more fusible instructions. The term “YES” comprises an indication that may be manifested in the form of a bit that is set or reset (e.g., 1/0, or ON/OFF), a logical indication such as TRUE/FALSE, or some other indication that the associated instruction is the first fusible instruction in a series of fusible instructions. Further, the term “YES” may include an indication of the type of instruction (e.g., an add instruction), possibly in the form of the opcode for the fusible instruction, or a decoded form of the opcode.

Similarly, the information included in the fourth row 228 indicates that physical register RP1 is a source register, typically used to contain source operands, associated with the second fusible instruction (e.g., a load instruction). The physical register RP4 is indicated as a destination register associated with the second fusible instruction, and is typically used to contain a destination operand. As noted previously, one, two or more source registers may be associated with the second fusible instruction, as well as one, two or more destination registers, if desired.

The term “NO” in table 200 indicates that the associated instruction (i.e., the second fusible instruction) is not the first fusible instruction in a series of fusible instructions. The term “NO” comprises an indication which may be manifested in the form of a bit that is set or reset (e.g., 1/0, or ON/OFF), a logical indication such as TRUE/FALSE, or some other indication that the associated instruction is not the first fusible instruction in a series of fusible instructions. While there may be an indication that the instruction is not the first fusible instruction in a series, the indication may also be an opcode for the associated instruction, or a decoded version thereof.

When the second fusible instruction is processed, the physical destination register RP4 is written into the table 200, and the source operand register RP1 is looked up. However, since the table 200 indicates that register RP1 is written by a fusible instruction, and the second fusible instruction is not indicated to be the first fusible instruction in the series of fusible instructions, the first and second fusible instructions can be fused, with the physical source registers RP2 and RP3 used as the source of operands in each case. It should be noted that the indications of fusible instructions 220 may contain any information that can be decoded in association with the instruction, or its opcode, such as the opcode itself, an immediate operand of the instruction, etc.

Thus, it should be noted that that fusing logic 124, 224, is capable of being communicatively coupled to the table 100, 200, wherein lookup of an operand associated with a second fusible instruction included in the table 100, 200 determines that the operand was produced by a fusible instruction type associated with the first fusible instruction, that the fusing logic may substitute for the second fusible instruction a new fused instruction that takes as a source operand at least one physical source operand associated with the first fusible instruction, and that the fusing logic may produce as a destination operand a physical destination operand associated with the second fusible instruction.

FIG. 3 is a block diagram of an apparatus, an article including a machine-accessible medium, and a system according to various embodiments of the invention. The apparatus 324, which may comprise fusing logic, including fusing decision logic 325, can include a rename stage 300 of a pipeline, having read ports 332 and write ports 336, which may correspond directly to the columns of the tables 100, 200 shown in FIGS. 1 and 2, respectively. For example, the physical source registers 322a and 322b, and physical destination register 322c may correspond to the physical source register identifiers 114 and the physical destination identifiers 118 shown in FIG. 1, respectively. The rename stage 300 may be preceded by some form of instruction decoder (not shown). The register state of the rename stage 300 may be carried via the pathway 338.

Inputs to the apparatus 324 may include the logical destination 342 (e.g., a register having a logical register index, perhaps indicated in a binary fashion as a series of addresses from 00h to FFh) and the fuse indication 346 (e.g., a register having an indication as to whether an associated instruction is fusible), which can be decoded from the instruction (e.g., as part of the instruction opcode). Inputs may also include one or more logical register source indices, such as logical source “a” 310 and logical source “b” 310 (e.g., registers having indices stored therein).

The allocator 348 maintains pools of physical registers, including a pool associated with those physical registers currently in use, and a pool associated with those physical registers that are available for use. Thus, when a logical destination is designated, an available physical register 322a, 322b, 322c can be allocated and mapped to it. The physical registers 322, including the physical source registers 322a and 322b, and the physical destination register 322c are capable of being communicatively coupled to the rename stage 300 and the bypass element 352. The multiplexers 354 can be used to select an appropriate “row” of the rename stage 300, and the fuse decision logic 325 determines whether the decoded instructions presented to the read ports 332 are fusible instructions.

The bypass element 352 allows the rename stage 300 to be effectively read and updated (i.e., written) in a single clock cycle. Thus, when read and write operations occur back-to-back, the bypass element 352 immediately provides values that have been written to the stage 300, without waiting for such values to be read. Considering the previous example, if execution of the add instruction is followed immediately by execution of the load instruction, and the result of the add instruction (i.e., the content of the register RP1 in FIG. 2) has yet to be written to the rename stage 300, the bypass element 352 detects these circumstances and forwards the unwritten result for use by the load instruction.

After reading the content of this disclosure, it will be realized that embodiments of the invention may take many forms. For example, an apparatus 324 may comprise a memory (e.g., a series of registers or memory locations) 300 including a table 362 indexed by a logical register identifier 310 associated with a physical register 322, and a memory location 364 capable of indicating a first fusible instruction (e.g. an add instruction, a load instruction, a branch instruction, etc.) associated with the physical register 322. The apparatus 324 may also comprise a memory location 366 capable of indicating an association between the first fusible instruction and a second fusible instruction (e.g., a load instruction, a multiply instruction, a branch instruction, etc.). In addition, the apparatus 324 may comprise a memory 300 including a table 362 indexed by a logical register identifier 310 associated with a physical register 322, and fusing decision logic 325 capable of being communicatively coupled to the memory 300. The memory 300 may itself include both the memory location 364 capable of indicating the first fusible instruction associated with the physical register 322, and the memory location 366 capable of indicating an association between the first fusible instruction and the second fusible instruction. The table 362 may comprise a rename table.

As shown in FIG. 3, in an alternative embodiment, a system 370 may comprise a memory location 372 capable of including an indication of a fusible instruction associated with a physical register 322 and a bypass element 352 to receive the indication. The indication of the fusible instruction can be decoded from an opcode associated with the fusible instruction. The system 370 may also include a memory 374 to receive an indication of a physical destination register 322c associated with the fusible instruction, as well as a memory 376 to receive an indication of at least one physical source register 322a and/or 322b associated with the fusible instruction.

All registers shown in FIGS. 1 and 2 (Psrca0-PsrcaN, Psrcb0-PsrcbN, Fuse0-FuseN, Pdest0-PdestN, RP1-RP4), the rename tables 100, 200, logical register identifiers 110, 210, source register identifiers 114, 214, physical destination register identifiers 118, 218, indications of fusible instructions 120, 220, physical registers 122, 222, fusing logic 124, 224, 324, fuse decision logic 325, rows 226, 228, rename stage 300, apparatus 324, read ports 332, write ports 336, physical source registers 322a and 322b, physical destination register 322c, pathway 338, logical destination 342, fuse indication 346, allocator 348, bypass element 352, multiplexers 354, table 362, memory locations 364, 366, 372, system 370, and memories 374, 376 may all be characterized as “modules” herein. Such modules may include hardware circuitry, and/or a processor and/or memory circuits, software program modules, and/or firmware, and combinations thereof, as desired by the architect of the apparatus 324 and the system 370, and as appropriate for particular implementations of various embodiments of the invention.

It should also be understood that the apparatus and systems of various embodiments of the invention can be used in applications other than for computers, and other than for systems which include pipelined processors, and thus, embodiments of the invention are not to be so limited. The illustrations of an apparatus 324 and a system 370 are intended to provide a general understanding of the structure of various embodiments of the invention, and they are not intended to serve as a complete description of all the elements and features of apparatus and systems that might make use of the structures described herein.

Applications which may include the novel apparatus and systems of various embodiments of the invention include electronic circuitry used in high-speed computers, communication and signal processing circuitry, modems, processor modules, embedded processors, and application-specific modules, including multilayer, multi-chip modules. Such apparatus and systems may further be included as sub-components within a variety of electronic systems, such as televisions, cellular telephones, personal computers, workstations, radios, video players, vehicles, and others.

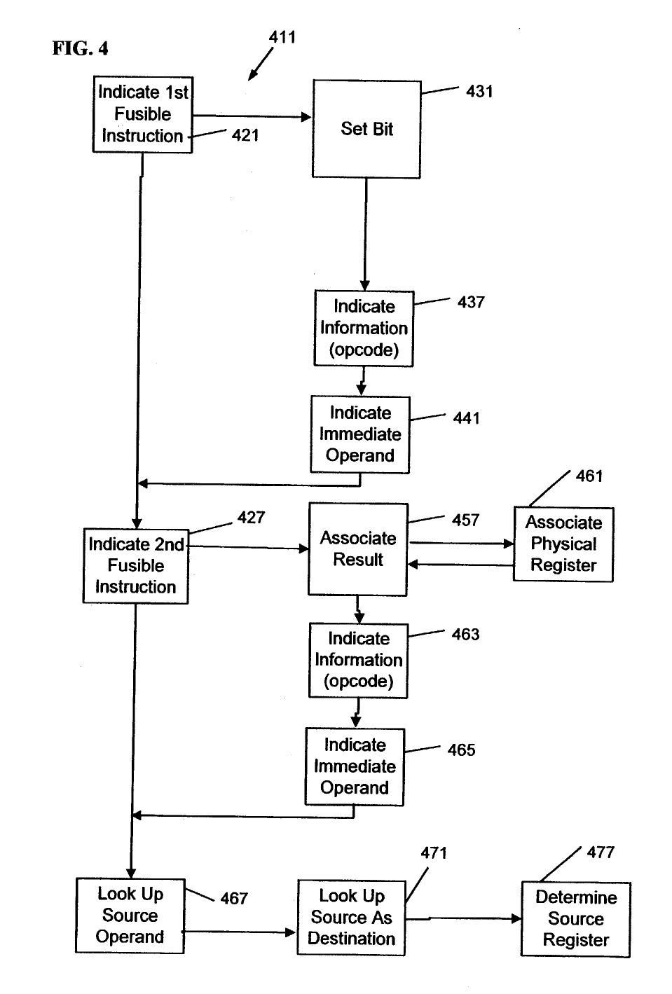

FIG. 4 is a flow chart illustrating a method 411 according to various embodiments of the invention. The method 411 may begin with indicating a first fusible instruction in a rename table at block 421, and continue with indicating a second fusible instruction associated with the first fusible instruction in the rename table at block 427.

Indicating the first fusible instruction in the rename table at block 421 may further include setting a bit in the rename table associated with the first fusible instruction at block 431. Indicating the first fusible instruction in the rename table at block 421 may also comprise indicating information associated with an opcode (or the opcode itself) associated with the fusible instruction at block 437, as well as indicating an immediate operand associated with the first fusible instruction at block 441.

Indicating the second fusible instruction associated with the first fusible instruction in the rename table at block 427 may include associating at least one result of the first fusible instruction with the second fusible instruction at block 457. Associating the at least one result of the first fusible instruction with the second fusible instruction may include associating a physical register with the second fusible instruction, the physical register to contain the at least one result, at block 461. The source operand associated with the second fusible instruction may be contained in a physical register associated with a destination operand of the first fusible instruction.

As is the case with indicating the first fusible instruction, indicating the second fusible instruction associated with the first fusible instruction in the rename table at block 427 may also comprise indicating information associated with an opcode (or the opcode itself) associated with the second fusible instruction at block 463, as well as indicating an immediate operand associated with the second fusible instruction at block 465.

The method 411 may also include looking up a source operand associated with the second fusible instruction at block 467, as well as looking up at least one source operand associated with the second fusible instruction as a destination operand associated with the first fusible instruction at block 471. Looking up at least one source operand associated with the second fusible instruction as a destination operand associated with the first fusible instruction may comprise determining a source register capable of containing the at least one source operand at block 477.

Thus, a number of activities may be associated with the rename table. For example, the rename table may be indexed by a logical register number, and produce upon lookup a physical register number corresponding to the logical register number. Further, the rename table may include a field indicating a physical register corresponding to a logical register, and one or more fields indicating physical source registers and instruction types that correspond to a last producer instruction for the logical register. Finally, a rename table entry corresponding to an instruction destination register associated with the first fusible instruction may be updated with: a new physical register allocated from a pool of available registers, physical registers corresponding to source operands of the first fusible instruction, and the instruction type, or information decoded from the instruction type (associated with the first fusible instruction).

It should be noted that the methods described herein do not have to be executed in the order described, or in any particular order. Moreover, various activities described with respect to the methods identified herein can be executed in serial or parallel fashion. Information, including parameters, commands, operands, and other data can be sent and received in the form of one or more carrier waves.

Thus, referring back to FIGS. 1-3, it is now easily understood that another embodiment of the invention may include an article 100, 200, 300 such as a computer, a memory system, a magnetic or optical disk, some other storage device, and/or any type of electronic device or system, comprising a machine-accessible medium such as a memory 124, 224, 332, 336 (e.g., a memory including an electrical, optical, or electromagnetic conductor) having associated data (e.g. computer program instructions), which when accessed, results in a machine performing such actions as indicating a first fusible instruction in a rename table, and indicating a second fusible instruction associated with the first fusible instruction in the rename table. Indicating the first fusible instruction in the rename table may also comprise indicating information associated with an opcode (or the opcode itself) associated with the fusible instruction, as well as indicating an immediate operand associated with the first fusible instruction.

Although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description.

The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description of Embodiments of the Invention, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

What is claimed is:

1. A method, comprising:
indicating a first fusible instruction in a rename table; and
indicating a second fusible instruction associated with the first fusible instruction in the rename table.

2. The method of claim 1, wherein indicating the first fusible instruction in the rename table further includes:
setting a bit in the rename table.

3. The method of claim 1, wherein indicating the second fusible instruction associated with the first fusible instruction in the rename table further includes:
associating at least one result of the first fusible instruction with the second fusible instruction.

4. The method of claim 3, wherein associating the at least one result of the first fusible instruction with the second fusible instruction further includes:
associating a physical register with the second fusible instruction, the physical register to contain the at least one result.

5. The method of claim 1, further comprising:
looking up a source operand associated with the second fusible instruction.

6. The method of claim 5, wherein the source operand associated with the second fusible instruction is contained in a physical register associated with a destination operand of the first fusible instruction.

7. The method of claim 1, wherein the rename table is indexed by a logical register number, and produces upon lookup a physical register number corresponding to the logical register number.

8. The method of claim 1, wherein the rename table includes a field indicating a physical register corresponding to a logical register, and one or more fields indicating physical source registers and instruction types that correspond to a last producer instruction for the logical register.

9. The method of claim 1, wherein a rename table entry corresponding to an instruction destination register associated with the first fusible instruction is updated with a new physical register allocated from a pool of available registers, physical registers corresponding to source operands of the first fusible instruction, and information decoded from an instruction type associated with the first fusible instruction.

10. The method of claim 1, further comprising:
looking up at least one source operand associated with the second fusible instruction as a destination operand associated with the first fusible instruction.

11. The method of claim 10, wherein looking up at least one source operand associated with the second fusible instruction as a destination operand associated with the first fusible instruction further comprises:
determining a source register capable of containing the at least one source operand.

12. An article comprising a machine-accessible medium having associated data, wherein the data, when accessed, results in a machine performing:
indicating a first fusible instruction in a rename table; and
indicating a second fusible instruction associated with the first fusible instruction in the rename table.

13. The article of claim 9, wherein indicating the first fusible instruction in the rename table further comprises:
indicating information associated with an opcode associated with the fusible instruction.

14. The article of claim 9, wherein indicating the first fusible instruction in the rename table further comprises:
indicating an opcode associated with the first fusible instruction.

15. The article of claim 9, wherein indicating the first fusible instruction in the rename table further comprises:
indicating an immediate operand associated with the first fusible instruction.

16. An apparatus, comprising:
a memory including a table indexed by a logical register identifier associated with a physical register; and
a fusing decision logic capable of being communicatively coupled to the memory.

17. The apparatus of claim 16, further comprising:
a memory location capable of indicating a first fusible instruction associated with the physical register, wherein lookup of an operand associated with a second fusible instruction included in the table determines that the operand was produced by a fusible instruction type associated with the first fusible instruction.

18. The apparatus of claim 16, further comprising:
a memory location capable of indicating an association between the first fusible instruction and a second fusible instruction.

19. The apparatus of claim 18, wherein the memory includes the memory location capable of indicating the first fusible instruction associated with the physical register and the memory location capable of indicating the association between the first fusible instruction and the second fusible instruction, and wherein the table comprises a rename table.

20. The apparatus of claim 18, wherein the first fusible instruction is an ADD instruction, and wherein the second fusible instruction is a LOAD instruction.

21. The apparatus of claim 18, wherein the first fusible instruction is a COMPARE instruction, and wherein the second fusible instruction is a BRANCH instruction.

22. A system, comprising:
a memory location capable of including an indication of a fusible instruction associated with a physical register; and
a bypass element to receive the indication.

23. The system of claim 22, wherein the indication of the fusible instruction is to be decoded from an opcode associated with the fusible instruction.

24. The system of claim 22, further comprising:
a memory to receive an indication of a physical destination register associated with the fusible instruction.

25. The system of claim 22, further comprising:
a memory to receive an indication of at least one physical source register associated with the fusible instruction.
